(19) United States
(12) Patent Application Publication
(10) Pub. No.: US 2002/0122463 A1
(43) Pub. Date: Sep. 5, 2002

(54) Generation of spread-spectrum multiple access codes with zero-correlation windows

(76) Inventor: Daoben Li, Beijing (CN)

Correspondence Address: Pennie & Edmonds, LLP, 3300 Hillview Avenue, Palo Alto, CA, 94304, US

(21) Appl. No.: 10/010,851

(22) Filed: Dec. 5, 2001

Related U.S. Application Data
(63) Continuation-in-part of application No. PCT/CN00/00179, filed on Jun. 26, 2000.

(51) Int. Cl. H04B 1/69

(52) U.S. Cl. 375/140

(57) ABSTRACT

Spread spectrum multiple access codes for use in a spread spectrum multiple access communications system and a method of generating such codes are disclosed. In one embodiment, an N-bit spread spectrum code is first transformed with an ideal periodic auto-correlation function to an orthogonal group of spread spectrum multiple access codes. Then, each code's length is extended by 2Δ elements, where Δ denotes a predetermined width of a desired zero-correlation window for the code's auto-correlation function. The extended codes can be used for the spread operation, and the non-extended codes can be used for the de-spread operation.

The present application is a continuation-in-part of, and claims priority under 35 U.S.C. §§120 and 365(c) to co-pending PCT application PCT/CN00/00179, filed Jun. 26, 2000, designating multiple countries including the United States, but was not published in English under PCT Article 21(2).

### RELATED APPLICATIONS

The present application is related to PCT application bearing PCT/CN00/00092, filed Apr. 18, 2000, and co-pending United States patent application entitled “Spread Spectrum Multiple Access Codes and Code Groups Generated by Rotation Transformation,” filed herewith and bearing attorney docket number 10748-0003-999. The aforementioned United States patent application is hereby incorporated by reference in its entirety.

### FIELD OF THE INVENTION

The present invention relates generally to spread spectrum technology and digital mobile communication technology. More particularly, the present invention relates to the generation of spread-spectrum multiple access codes with desirable non-periodic auto-correlation and cross-correlation functions.

### BACKGROUND OF THE INVENTION

A wireless communication channel is a typically a time-varying channel that is affected by many random factors such as angle, frequency (produced by Doppler frequency spread), and time (produced by multi-path propagation) dispersion. Random angle dispersion causes signals at different receiving points to fluctuate randomly (i.e., spatial-selective fading). Random frequency dispersion causes received signals to fluctuate randomly with time (i.e., time-selective fading). Random time dispersion causes different frequency spectrum components of a received signal to fluctuate randomly (i.e., frequency-selective fading). Spatial-selective, time-selective and frequency-selective fading all significantly deteriorate the performance and capacity of the wireless communication channel.

One approach to overcoming the problem of fading is by using diversity reception. In general, diversity reception refers to techniques for improving the Signal-to-Noise Ratio (SNR) of a communication channel by suitably combining a number of signal transmission paths that carry the same information but have uncorrelated fading. In digital wireless spread spectrum communication systems, it is advantageous to use high quality spread spectrum codes (e.g., codes that have desirable auto-correlation and cross-correlation characteristics, etc.) to take full advantage of diversity reception.

In the prior art, most high quality spread spectrum codes and code groups were found by computer searches. Computer searching, however, is costly, time consuming and does not always produce the desired high quality spread spectrum codes or code groups.

In view of the foregoing, there exists a need for a method of generating high quality spread spectrum codes and code groups.

### SUMMARY OF THE INVENTION

An embodiment of the present invention is a method of constructing an orthogonal group of spread spectrum multiple access codes each having a non-periodic auto-correlation function that has no side-lobe within a predefined window. The width of the predefined window may be varied according to practical requirements. Some non-periodic cross-correlation side lobe values may not be exactly zero within the predefined window. Nevertheless, the cross-correlation side lobe values are so small that they are practically negligible.

According to an embodiment of the present invention, the method of constructing an orthogonal group of spread spectrum multiple access codes includes the following steps:

Select an N-bit spread spectrum code with an ideal periodic auto-correlation function.

Transform the selected spread spectrum code using orthogonal rotation to form an orthogonal group of spread spectrum codes. This group contains N spread spectrum codes that are completely orthogonal with respect to each other.

Extend each of the N spread spectrum codes produced in the transformation step by 2Δ elements to form a group of spread spectrum codes each having N+2Δ elements, where Δ denotes a predefined width of the zero-correlation window of the non-periodic auto-correlation function of the spread spectrum codes. In one embodiment, each one of the N spread spectrum codes may be extended by appending Δ elements at the beginning of the sequence and by appending Δ elements at the end.

Evaluate the non-periodic cross-correlation functions of all the spread spectrum codes of the group.

Select the spread spectrum codes with the smallest cross-correlation functions to form a new group of spread spectrum codes.

The new group of spread spectrum codes may be used for the spreading operation in a spread spectrum communication system. The same orthogonal group of spread spectrum codes may be used for de-spreading operations at the receiver, after removing the beginning Δ elements and the ending Δ elements from each sequence by setting them to zero.

Some advantages of the present invention include:

The present invention transforms the problem of searching for a spread spectrum multiple access code that has a non-periodic correlation function with a zero-correlation window into the simpler problem of searching for a spread spectrum multiple access code that has an ideal periodic correlation function. It thereby simplifies the searching method and extends the searching scope.

The properties of the orthogonal group of spread spectrum codes provided by embodiment(s) of the present invention are substantially independent of the original phase of each spread spectrum code. More precisely, the auto-correlation function of each spread spectrum code is totally independent of its original phase, and for the cross-correlation function, only a fixed phase shift is introduced. As a result, communication channels encoded with the spread spectrum codes can withstand to some extent Doppler frequency shifts and channel phase swings.

### BRIEF DESCRIPTION OF THE DRAWINGS

For a better understanding of the invention, reference should be made to the following detailed description taken in conjunction with the accompanying drawings, in which:

FIG. 1A depicts a non-periodic auto-correlation function and its zero-correlation window of a spread spectrum multiple access code.

FIG. 1B depicts a non-periodic cross-correlation function and its zero-correlation windown between two spread spectrum multiple access codes.

FIG. 2 depicts an extended code sequence according to one embodiment of the present invention.

FIG. 3 is a block diagram of a transmitter device according to one embodiment of the present invention.

FIG. 4 is a block diagram of a transmitter device according to another embodiment of the present invention.

FIG. 5 is a block diagram of a receiver device according to one embodiment of the present invention.

FIG. 6 is a block diagram of a receiver device according to another embodiment of the present invention.

### DESCRIPTION OF THE PREFERRED EMBODIMENTS

As used herein, a non-periodic auto-correlation function of a spread spectrum code, b=[b₀, b₁, b₂, . . . b_{N-1}], is determined by:

$${r}_{b} ( k ) = \frac{1}{{‖ b ‖}^{2}} {\sum }_{n = 0}^{N - 1} {b}_{n} {b}_{n + k}^{*} \qquad ( 1 )$$

where b* denotes the complex conjugate of b and where

$${‖ b ‖}^{2} ≡ {\sum }_{n = 0}^{N - 1} {b}_{n} {b}_{n}^{*} \qquad ( 2 )$$

In the prior art, an ideal spread spectrum code is defined to be a spread spectrum code with a non-periodic auto-correlation function that is zero everywhere except at the origin; in other words, the ideal spread spectrum code has no side-lobe. In the prior art, an ideal spread spectrum code group is defined to be a group of spread spectrum codes where all the codes have no side-lobe and every non-periodic cross-correlation function of the group must be zero everywhere. Unfortunately, theoretical studies and computer searches show that such ideal spread spectrum codes and code groups do not exist under the complex number field.

In PCT application bearing application number PCT/CN00/00028, entitled: “Coding Method for Spread Spectrum Multiple Access Code with Zero Correlation Window,” the inventor herein pointed out that the requirements for ideal spread spectrum multiple access codes can be relaxed when bi-directional synchronization is applied. The relaxed requirements are as follows:

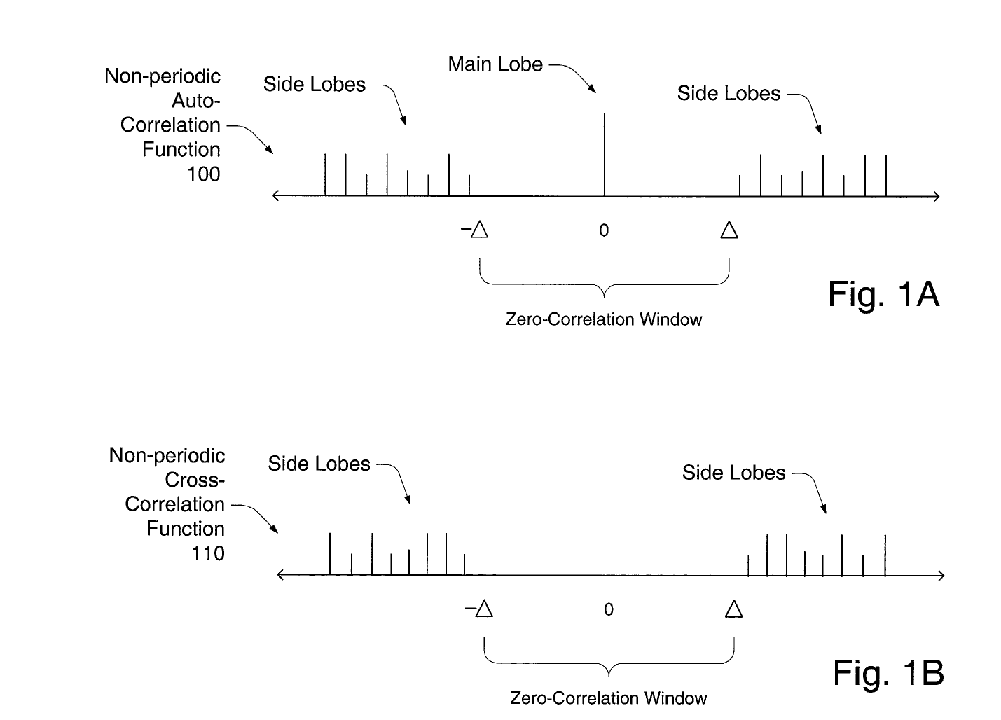

The side-lobe values for the non-periodic auto-correlation functions of spread spectrum multiple access codes do not need to be zero everywhere. The side-lobe values need to be zero only within a window (−Δ, Δ), where Δ represents the sum of the maximum time dispersion and the maximum timing error of the communication channel where the spread spectrum multiple access codes are used. The non-periodic auto-correlation function 100 of a spread spectrum multiple access code is illustrated in FIG. 1A. As shown, the non-periodic auto-correlation function 100 has a zero-correlation window within which the function is zero or close to zero.

The non-periodic cross-correlation functions of the spread spectrum multiple access codes do not need to be zero everywhere. The non-periodic cross-correlation functions of the spread spectrum multiple access codes need to be zero, or close to zero, only within the window (−Δ, Δ). The non-periodic cross-correlation function 110 between two spread spectrum multiple access code is illustrated in FIG. 1B. As shown, the non-periodic cross-correlation function 110 has a zero-correlation window within which the function is zero or close to zero.

In PCT Application bearing application number PCT/CN00/00092, entitled “Orthogonal Transformation Method for Spread Spectrum Multiple Access Coding,” and co-pending United States patent application entitled “Spread Spectrum Multiple Access Codes and Code Groups Generated by Rotation Transformation,” the inventor herein disclosed a method of transforming a initial spread spectrum code to an orthogonal group of spread spectrum access codes. A significant characteristic of that transformation method is that, after applying multiple orthogonal rotation transformations, the resulting codes remain orthogonal to each other. In addition, the auto-correlation function of each of the resulting codes is substantially consistent with that of the initial spread spectrum code, except for a small amount of fixed phase shift.

In addition to inventing the subject matter disclosed in the above-mentioned PCT applications, the inventor herein has henceforth invented the subject matter of the present application. In one embodiment, the present invention provides a novel method of generating a group of spread-spectrum multiple access codes each having a non-periodic auto-correlation function with a zero-correlation window. Furthermore, the cross-correlation functions of the spread-spectrum multiple access codes are almost zero. The spread-spectrum multiple access codes generated can thus be considered “ideal” under the relaxed requirements.

In particular, according to one embodiment of the present invention, the method includes the following steps:

Step 1

Select a spread spectrum code with an ideal periodic auto-correlation function and a length of N:

b=[b₁, b₁, b₂, . . . , b_{N-2}, b_{N-1}]

In the present discussion, an ideal periodic auto-correlation function refers to:

$$\begin{matrix}{r}_{b} ( k ) = \frac{1}{{‖ b ‖}^{2}} {\sum }_{n = 0}^{N - 1} {b}_{n} {b}_{n + k mod N}^{*} , \vert k \vert \leq N \\ = \{ \begin{matrix}1 \\ 0\end{matrix} \begin{matrix}k = 0 \\ k \neq 0\end{matrix}\end{matrix} \qquad ( 3 )$$

where mod N denotes a modular N operation, where b* is the complex conjugate of b; and

$${‖ b ‖}^{2} ≡ {\sum }_{n = 0}^{N - 1} {b}_{n} {b}_{n}^{*} \qquad ( 4 )$$

Note that, according to equation (3) above, the n-th bit of the code b is multiplied by the ((n+k)mod N)-th bit of the complex conjugate b*. For example, if N=4, and if k=1, then when n=3, (n+k)mod N=0, and

r_{b}(1)=b₀×b₁+b₁×b₂+b₂×b₃+b₃×b₀

An example of a spread spectrum code with an ideal periodic auto-correlation function is the broadcast spread spectrum code of the Large Area Synchronous CDMA system (LAS-CDMA), which is a proprietary technology of LinkAir Communications, Inc. Additional information about the LAS-CDMA technology can be found on the World Wide Web at the URL address: www.linkair.com.

The broadcast spread spectrum code of LAS-CDMA is a ternary sequence s₀ with twenty-one elements in length:

s₀=[+++++−+0+0−++−00+−0−−]

It can be easily verified that the periodic auto-correlation function of this ternary sequence is ideal. It can also be verified that any cyclically shifted version of sequence s₀ also has a perfectly ideal periodic auto-correlation function.

Step 2

Apply an orthogonal rotation transformation on b₀ to form a group of spread spectrum codes, {b₀, b₁, . . . , b_{N-1}}. The group has N spread spectrum codes that are completely orthogonal to each other. The N spread spectrum codes are:

b₀=[b₀, b₁, b₂, . . . , b_{N-2}, b_{N-1}]

b₁=[b₀, b₁e^{jΔψ}, b₂e^{j2Δψ}, . . . , b_{N-2}e^{j(N-2)Δψ}, b_{N-1}e^{j(N-1)Δψ}]

b₂=[b₀, b₁e^{j2Δψ}, b₂e^{j4Δψ}, . . . , b_{N-2}e^{j2(N-2)Δψ}, b_{N-1}e^{j2(N-1)Δψ}]

. . .

bₖ=[b₀, b₁e^{jkΔψ}, b₂e^{j2kΔψ}, . . . , b_{N-2}e^{jk(N-2)Δψ}, b_{N-1}e^{jk(N-1)Δψ}]

b_{N-1}=[b₀, b₁e^{j(N-1)Δψ}, b₂e^{j2(N-1)Δψ}, . . . , b_{N-2}e^{j(N-1)(N-2)Δψ}, b_{N-1}e^{j(N-1)(N-1)Δψ}]

. . .

where

$$Δ ϕ = \frac{2 π}{N} .$$

Orthogonal rotation transformation is described in detail in the above referenced patent co-pending U.S. patent application and PCT application PCT/CN00/00092.

Any one of the sequences bₗ (l=0, 1, . . . , N−1) generated by the orthogonal rotation transformation has an ideal periodic auto-correlation function. The relative rotations between any two sequences are integral periods, and every pair of sequences is orthogonal to each other. Therefore, N mutually orthogonal sequences with an ideal periodic auto-correlation function will result from an orthogonal rotation transformation of a sequence with an ideal periodic auto-correlation function.

Step 3

Extend the length of each sequence bₗ (l=0, 1, . . . , N−1) in the mutually orthogonal group by 2Δ elements to form a new set of sequences aₗ (l=0, 1, . . . , N−1) each having a length of N+2Δ elements. In the present embodiment, Δ represents the desired width of the zero correlation window, which generally corresponds to the maximum tolerance of the communication system in which the codes are used. In some embodiments, the desired width of the zero correlation window is the sum of the maximum time dispersion and the maximum timing error of a communication channel of the communication system.

The new sequences are as follows:

$$\begin{matrix}{a}_{0} = [ {b}_{N - Δ + 1} , {b}_{N - Δ + 2} , … , {b}_{N - 1} , \\ {b}_{0} , {b}_{1} , {b}_{2} , … , {b}_{N - 2} , {b}_{N - 1} , {b}_{0} , {b}_{1} , … , {b}_{Δ - 1} ] \\ ⋮ \\ {a}_{l} = [ {b}_{N - Δ + 1} {ⅇ}^{j ( N - Δ + 1 ) l Δ ϕ} , {b}_{N - Δ + 2} {ⅇ}^{j ( N - Δ + 2 ) l Δ ϕ} , … , \\ {b}_{N - 1} {ⅇ}^{j ( N - 1 ) l Δ ϕ} , {b}_{0} , {b}_{1} {ⅇ}^{j l Δϕ} , {b}_{2} {ⅇ}^{j 2 l Δϕ} , … , {b}_{N - 2} {ⅇ}^{j ( N - 2 ) l Δϕ} , \\ {b}_{N - 1} {ⅇ}^{j ( N - 1 ) l Δϕ} , {b}_{0} , {b}_{1} {ⅇ}^{j l Δϕ} , … , {b}_{Δ - 1} {ⅇ}^{j ( Δ - 1 ) l Δϕ} ]\end{matrix}$$

where l=0, 1 . . . , N−1.

As shown, the first Δ elements of each of the new sequences aₗ (l=0, 1, . . . , N−1) are the last Δ elements of the original sequences bₗ (l=0, 1, . . . , N−1), and the last Δ elements of the new sequences aₗ (l=0, 1, . . . , N−1) are the first Δ elements of the original sequences bₗ (l=0, 1, . . . , N−1). The middle N elements of the new sequences aₗ (l=0, 1, . . . , N−1) are the original sequences bₗ (l=0, 1, . . . , N−1).

Consider the broadcast spread spectrum code of LAS-CDMA as an example. As mentioned above, the broadcast spread spectrum code of LAS-CDMA is a ternary sequence s₀ with a length of twenty-one elements:

s₀=[+++++−+0+0−++−00+−0−−]

Suppose the desired width of the zero-correlation window is four (Δ=4). Then a₀ should be:

a₀=[−0−−+++++−+0+0−++−00+−0−−++++]

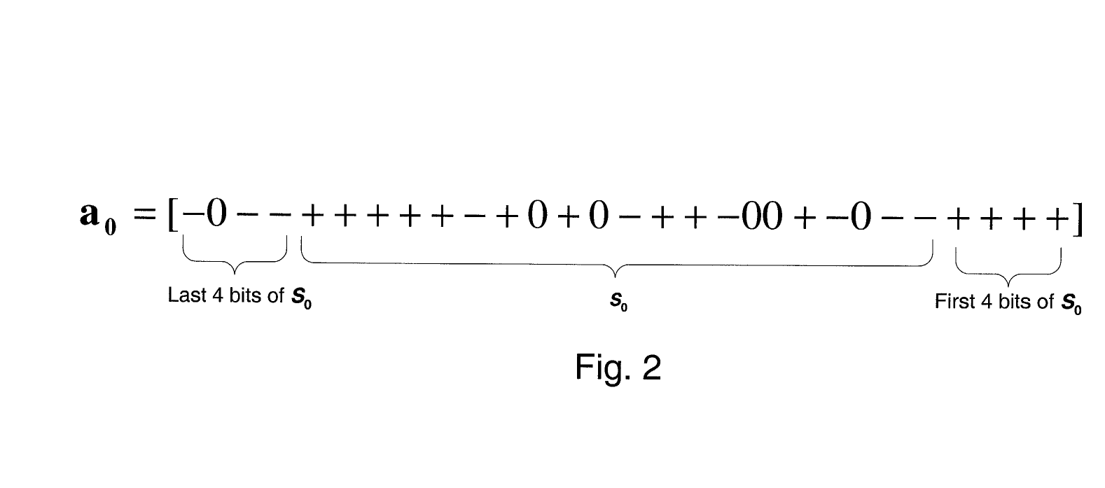

As illustrated in FIG. 2, the first four elements of a₀ are [−0−−] and the last four elements of a₀ are [++++]. The first four elements of a₀ correspond to the last four elements of s₀, and the last four elements of a₀ correspond to the first four elements of s₀.

Observe that, when k<Δ, the non-periodic auto-correlation of aₗ (l=0, 1, . . . , N−1) is the periodic auto-correlation of bₗ. Furthermore, the non-periodic cross-correlation function between bₗ and aₗ (l=0, 1, . . . , N−1) is the periodic auto-correlation function of bₗ. Here, the beginning Δ elements and ending Δ elements of aₗ ensure that the width of zero correlation window is (−Δ, Δ). The actual spread spectrum function is provided by the N elements in the middle.

Step 4

Some of the spread spectrum codes generated the present embodiment may have undesirable cross-correlation functions. Thus, the present embodiment may include the steps of evaluating all non-periodic cross-correlation functions between bₗ and a_{l′} (l, l′=0, 1 . . . , N−1, l≠l′) and selecting N₀ spread spectrum codes that have smaller non-periodic cross-correlation functions from among all non-periodic cross-correlation functions between bₗ and a_{l′} (l, l′=0, 1 . . . , N−1, l≠l′). The number of spread spectrum codes selected depends on various factors including the tolerance of the communication system, the number of codes needed, etc. In this embodiment, the selected spread spectrum codes are {bₘ} and {ₘ}, (m=0, 1, . . . , N₀−1). The remaining unselected spread spectrum codes with undesirable cross-correlation functions are discarded.

In some embodiments of the present invention, step 4 can be omitted. In those embodiments, none of the spread spectrum codes is discarded, and the code groups {bₘ} and {aₘ} include the entire sets of bₗ and aₗ.

The newly generated code group {aₘ} is a group of spread spectrum codes that can be used for the spreading operations in a transmitting device. In a receiving device, the corresponding {bₘ}, which is the middle part of {aₘ} after removing the beginning Δ elements and ending Δ elements respectively, can be used for the de-spreading operations.

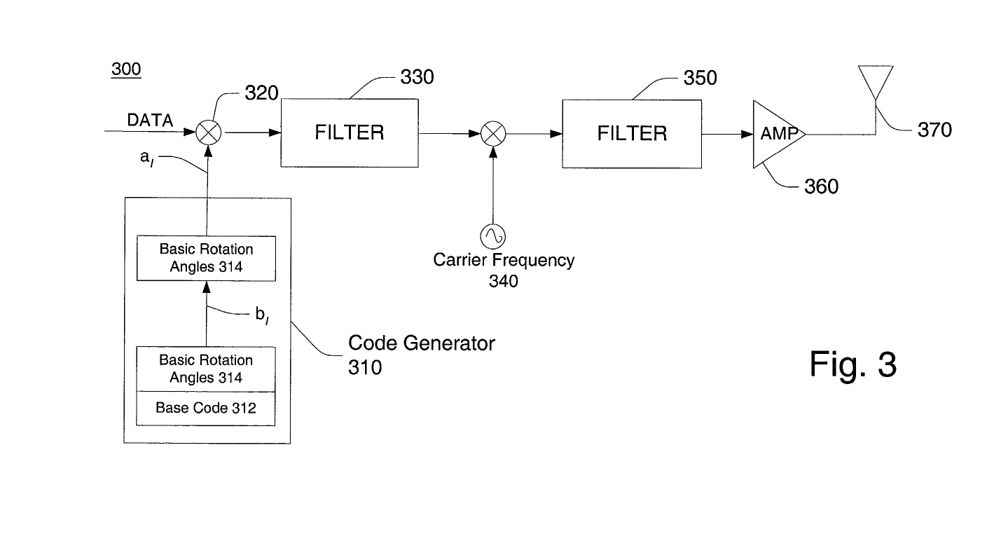

Code groups generated according to embodiments of the present invention can be used in a wide variety of communication systems. FIG. 3 depicts a block diagram of a transmitter 300 for a wireless communication system according to an embodiment of the present invention. The transmitter 300 may be implemented as part of a base station or a mobile unit. As depicted, transmitter 300 includes a code generator 310 that stores a predetermined spread spectrum code [b₀, b₁, b₂, . . . , b_{N-1}] (312) and a set of predetermined basic rotation angles Δψ, 2Δψ, 3Δψ . . . (N−1)Δψ (314). In this embodiment, the predetermined spread spectrum code 312 has an ideal periodic auto-correlation function. That is, the code 312 has no side-lobe. Using the predetermined code 312, the predetermined basic rotation angles, the code generator 310 generates a code bₗ that includes the following elements:

b₀, b₁e^{jlΔψ}, . . . , b_{N-1}e^{j(N-1)lΔψ}

The code bₗ is then extended by a predetermined number (Δ) of elements by a code extension unit 315 to produce a code aₗ, where

$$\begin{matrix}{a}_{l} = [ {b}_{N - Δ + 1} {ⅇ}^{j ( N - Δ + 1 ) l Δ ϕ} , {b}_{N - Δ + 2} {ⅇ}^{j ( N - Δ + 2 ) l Δ ϕ} , … , \\ {b}_{N - 1} {ⅇ}^{j ( N - 1 ) l Δ ϕ} , {b}_{0} , {b}_{1} {ⅇ}^{j l Δϕ} , {b}_{2} {ⅇ}^{j 2 l Δϕ} , … , {b}_{N - 2} {ⅇ}^{j ( N - 2 ) l Δϕ} , \\ {b}_{N - 1} {ⅇ}^{j ( N - 1 ) l Δϕ} , {b}_{0} , {b}_{1} {ⅇ}^{j l Δϕ} , … , {b}_{Δ - 1} {ⅇ}^{j ( Δ - 1 ) l Δϕ} ]\end{matrix}$$

In the present implementation, the code extension unit 315 includes logic for transposing the first Δ elements and the last Δ elements of the code bₗ, respectively, to the beginning and end of the extended code aₗ.

With reference still to FIG. 3, The extended code aₗ is then provided to a spreader circuit 320, which uses the code aₗ to spread the data to be transmitted. The spreaded data is then filtered by filter 330 and modulated by a carrier frequency 340. The modulated data is then filtered, amplified and transmitted via antenna 370. Note that the transmitter 300 of FIG. 3 depicts a simplified example of a wireless transmitter configuration that is well known in the art. Many other configurations consistent with the scope and principles of the present invention are also possible.

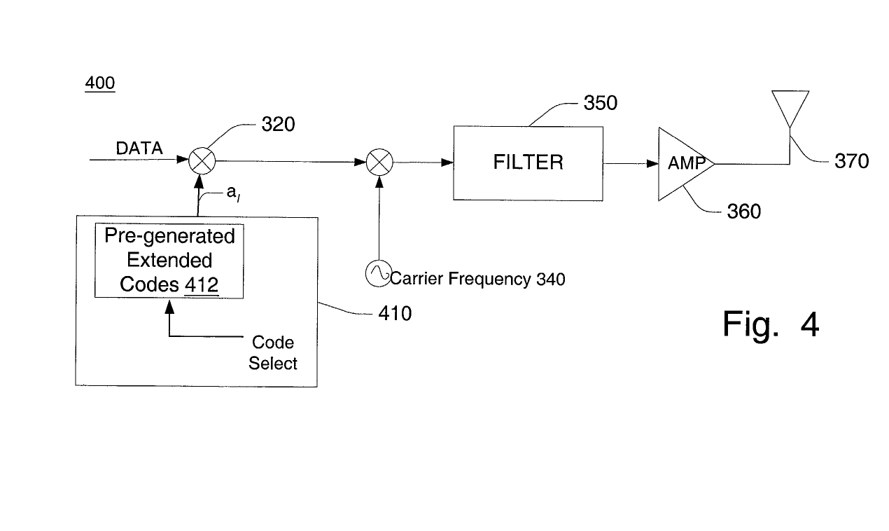

FIG. 4 depicts a simplified block diagram of a transmitter 400 for a wireless communication system according to another embodiment of the present invention. The transmitter 400 does not use a code generator for generating the codes. Rather, the transmitter 400 uses a memory 410 having stored therein a group of extended spread spectrum multiple access codes (412) that is generated according to an embodiment of the present invention disclosed above. Selection signals can be used to select a particular one of the codes of the code groups to be used by the transmitter 400 to spread the data to be transmitted.

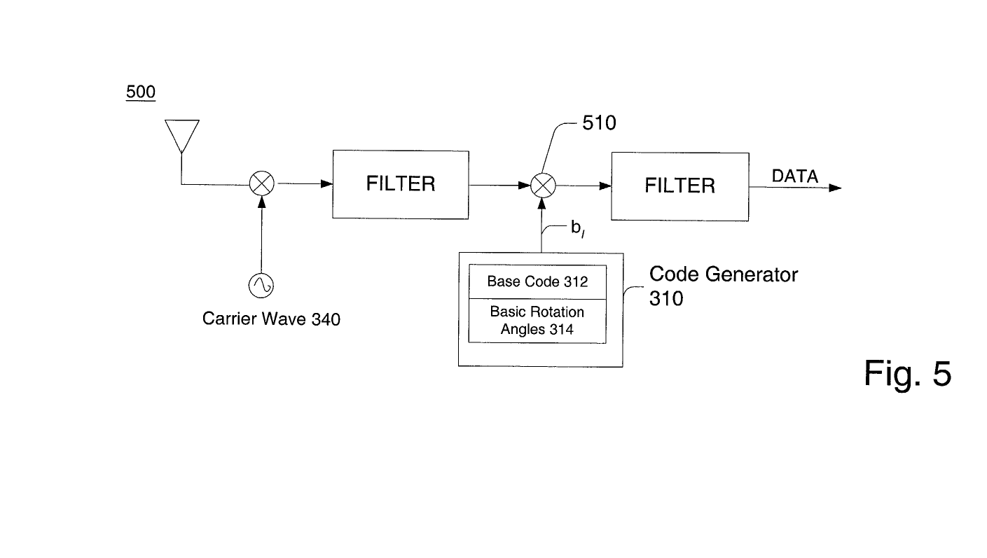

FIG. 5 depicts a block diagram of a receiver 500 for a wireless communication system according to an embodiment of the present invention. The receiver 500 may be used to receive data transmitted by transmitter 300 or 400, and may be implemented as part of a base station or a mobile station of the communication system. In FIG. 5, a despreading code is generated by a code generator according to the predetermined spread spectrum code [b₀, b₁, b₂, . . . , b_{N-1}] (312) and the set of predetermined basic rotation angles Δψ, 2Δψ, 3Δψ . . . (N−1)Δψ (314). The despreading code thus generated is used by a despreader 510 to de-spread received data. According to the present embodiment, the received data is spread by a code aₗ, where

$$\begin{matrix}{a}_{l} = [ {b}_{N - Δ + 1} {ⅇ}^{j ( N - Δ + 1 ) l Δ ϕ} , {b}_{N - Δ + 2} {ⅇ}^{j ( N - Δ + 2 ) l Δ ϕ} , … , \\ {b}_{N - 1} {ⅇ}^{j ( N - 1 ) l Δ ϕ} , {b}_{0} , {b}_{1} {ⅇ}^{j l Δϕ} , {b}_{2} {ⅇ}^{j 2 l Δϕ} , … , {b}_{N - 2} {ⅇ}^{j ( N - 2 ) l Δϕ} , \\ {b}_{N - 1} {ⅇ}^{j ( N - 1 ) l Δϕ} , {b}_{0} , {b}_{1} {ⅇ}^{j l Δϕ} , … , {b}_{Δ - 1} {ⅇ}^{j ( Δ - 1 ) l Δϕ} ]\end{matrix}$$

A code bₗ=[b₀, b₁e^{jlΔψ}, . . . , b_{N-1}e^{j(N-1)lΔψ] can be used for despreading the received data.}

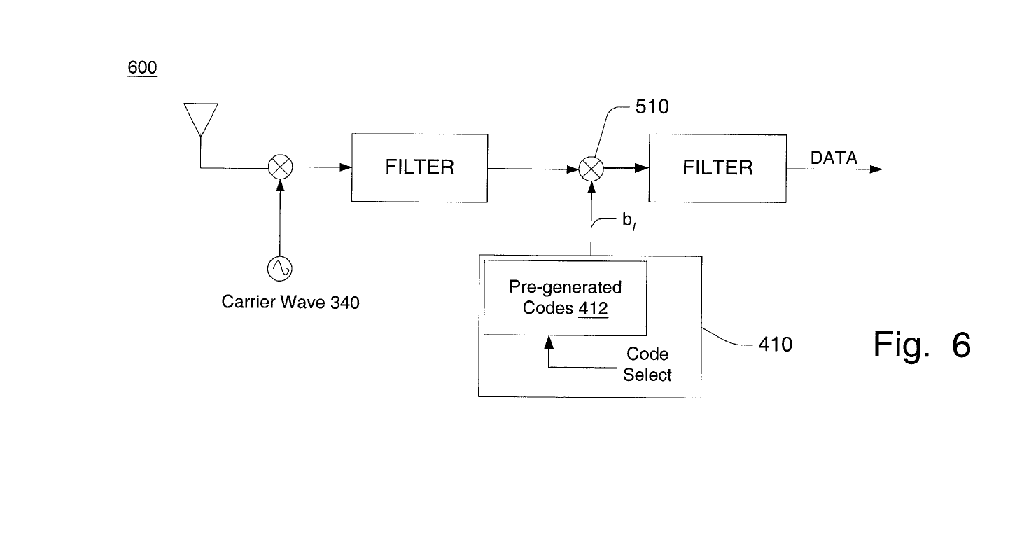

FIG. 6 depicts a block diagram of a receiver 600 for a wireless communication system according to another embodiment of the present invention. The receiver 600 may be used to receive data transmitted by transmitter 300 or 400, and may be implemented as part of a base station or a mobile station of the communication system. A code group 412 is stored in a memory unit 410 of the receiver 600. In FIG. 6, a code bₗ, which is one of the codes stored in the memory unit 410, is selected and used to despread received data. Again, in this embodiment, the selected code corresponds to the spreading code used by the transmitter.

The foregoing description, for purposes of explanation, used specific nomenclature to provide a thorough understanding of the invention. However, it will be apparent to one skilled in the art that the specific details are not required in order to practice the invention. In other instances, well known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described to best explain the principles of the invention and its practical applications, to thereby enable others skilled in the art to best utilize the invention and various embodiments with various modifications as are suited to the particular use contemplated.

What is claimed is:

1. A method of forming spread spectrum codes for use in a code division multiple access communication system, the method comprising:
selecting a spread spectrum code with an ideal periodic auto-correlation function;
extending the spread spectrum code with a plurality of elements to form an extended spread spectrum code, wherein a non-periodic auto-correlation function of the extended spread spectrum code has a zero-correlation window, wherein the extending (step) comprises:
appending a first plurality of elements to a first end of the spread spectrum code, the first plurality of elements being identical to elements at a second end of the spread spectrum code; and
appending a second plurality of elements to the second end of the spread spectrum code, the second plurality of elements being identical to elements at the first end of the spread spectrum code.

2. A method of forming spread spectrum codes for use in a code division multiple access communication system, the method comprising:
selecting a first spread spectrum code with an ideal periodic auto-correlation function;
forming a second spread spectrum code based on the first spread spectrum code, the second spread spectrum code having an ideal periodic auto-correlation function;
first extending the first spread spectrum code by a plurality of elements to form a first extended spread spectrum code; and
second extending the second spread spectrum code by a plurality of elements to form a second extended spread spectrum code, wherein the a non-periodic cross-correlation function of the first extended spread spectrum code and the second extended spread spectrum code has a zero-correlation window.

3. The method of claim 2, wherein the first extending comprises:
appending a first plurality of elements to a first end of the first spread spectrum code, the first plurality of elements being identical to elements at a second end of the first spread spectrum code; and
appending a second plurality of elements to the second end of the first spread spectrum code, the second plurality of elements being identical to elements at the first end of the first spread spectrum code.

4. The method of claim 3, wherein the second extending comprises:
appending a third plurality of elements to a first end of the second spread spectrum code, the third plurality of elements being identical to elements at a second end of the second spread spectrum code; and
appending a fourth plurality of elements to the second end of the second spread spectrum code, the fourth plurality of elements being identical to elements at the first end of the second spread spectrum code.

5. The method of claim 2, wherein a non-periodic auto-correlation function of the first extended spread spectrum code has a zero-correlation window and wherein a non-periodic auto-correlation function of the second extended spread spectrum code has a zero-correlation window.

6. A method of forming spread spectrum codes for use in a code division multiple access communication system, the method comprising:
forming a plurality of spread spectrum codes each having an ideal auto-correlation function; and
extending the plurality of spread spectrum codes to form a plurality of extended spread spectrum codes, wherein non-periodic cross-correlation functions among the extended spread spectrum codes each have a zero-correlation window.

7. The method of claim 6, wherein the extending comprises:
first extending a first one of the spread spectrum codes by a first plurality of elements to form a first extended spread spectrum code; and
second extending a second one of the spread spectrum codes by a second plurality of elements to form a second extended spread spectrum code.

8. The method of claim 7, wherein the first extending comprises:
appending a first plurality of elements to a first end of the first spread spectrum code, the first plurality of elements being identical to elements at a second end of the first spread spectrum code; and
appending a second plurality of elements to the second end of the first spread spectrum code, the second plurality of elements being identical to elements at the first end of the first spread spectrum code.

9. The method of claim 8, wherein the second extending (step) comprises:
appending a third plurality of elements to a first end of the second spread spectrum code, the third plurality of elements being identical to elements at a second end of the second spread spectrum code; and
appending a fourth plurality of elements to the second end of the second spread spectrum code, the fourth plurality of elements being identical to elements at the first end of the second spread spectrum code.

10. The method of claim 6, wherein the forming comprises:
selecting a first spread spectrum code with an ideal periodic auto-correlation function; and
producing a plurality of spread spectrum codes with ideal periodic auto-correlation functions by orthogonal rotation transformation of the first spread spectrum code.

11. The method of claim 6, wherein non-periodic auto-correlation functions of the extended spread spectrum codes each have a zero-correlation window.

12. A spread spectrum communication device, comprising:
a code generator operable to generate a first code that has an ideal periodic auto-correlation function;
a first extended code generator operable to generate a first extended code by appending a plurality of elements to the first code, wherein the first extended code has an ideal periodic auto-correlation function, and wherein a non-periodic auto-correlation function of the first extended code has a zero-correlation window; and
a first spreader operable to spread a first stream of data with the first extended code.

13. The spread spectrum communication device of claim 10, wherein the first extended code generator is operable to append a first plurality of elements to a first end of the first code and a second plurality of elements to the second end of the first code, wherein the first plurality of elements are identical to elements at a second end of the first code, and wherein the second plurality of elements are identical to elements at the first end of the first code.

14. The spread spectrum communication device of claim 11, wherein a width of the zero-correlation window of the non-periodic auto-correlation function of the first extended code equals to a combined length of the first plurality of elements and the second plurality of elements.

15. The spread spectrum communication device of claim 10, wherein the code generator is operable to generate a second code that has an ideal periodic auto-correlation function, the spread spectrum communication device further comprising:
a second extended code generator operable to generate a second extended code by appending a plurality of elements to the second code, wherein the second extended code has an ideal periodic auto-correlation function, wherein a non-periodic auto-correlation function of the second extended code has a zero-correlation window, and wherein a non-periodic auto-correlation function of the first extended code and the second extended code has a zero-correlation window;
a second spreader operable to spread a second stream of data with the second extended code.

16. The spread spectrum communication device of claim 13, wherein the second extended code generator is operable to append a third plurality of elements to a first end of the second code and a fourth plurality of elements to the second end of the second code, wherein the third plurality of elements are identical to elements at a second end of the second code, and wherein the fourth plurality of elements are identical to elements at the first end of the second code.

17. The spread spectrum communication device of claim 14, wherein a width of the zero-correlation window of the non-periodic auto-correlation function of the second extended code equals to a combined length of the third plurality of elements and the fourth plurality of elements, and wherein a width of the zero-correlation window of the non-periodic cross-correlation function equals to the combined length.

18. The spread spectrum communication device of claim 13, further comprising:
a receiver operable to receive a third stream of data that spread with the first extended code and a fourth stream of data that is spread with the second extended code;
a first despreader operable to despread the third stream of data with the first code; and
a second despreader operable to despread the fourth stream of data with the second code.

19. The spread spectrum communication device of claim 10, wherein the code generator comprises a memory operable to store the first code.

20. A spread spectrum communication network configured to operate in a first pre-defined territory and a second pre-defined territory, the network comprising:
a first communication device located in the first territory, the first communication device operable to generate a first extended code from a first pre-defined code and operable to spread data using the first extended code, wherein a non-periodic auto-correlation function of the first extended code has a zero-correlation window; and
a second communication device located in the second territory, the second communication device operable to generate a second extended code from a second pre-defined code and operable to spread data using the second extended code, wherein a non-periodic auto-correlation function of the second extended has a zero-correlation window, and wherein a non-periodic cross-correlation function of the first extended code and the second extended code has a zero-correlation window.

21. The spread spectrum communication network of claim 18, wherein the first communication device is operable to append a first plurality of elements to a first end of the first predefined code and a second plurality of elements to the second end of the first pre-defined code, wherein the first plurality of elements are identical to elements at a second end of the first pre-defined code, and wherein the second plurality of elements are identical to elements at the first end of the first pre-defined code, and wherein the second communication device is operable to append a third plurality of elements to a first end of the second pre-defined code and a fourth plurality of elements to the second end of the second pre-defined code, wherein the third plurality of elements are identical to elements at a second end of the second pre-defined code, and wherein the fourth plurality of elements are identical to elements at the first end of the second pre-defined code.

22. The spread spectrum communication network of claim 18, wherein the first communication device is operable to de-spread data with the first pre-defined code, and wherein the second communication device is operable to de-spread data with the second pre-defined code.

23. The spread spectrum communication network of claim 18, wherein the first communication device is operable to communicate with a mobile communication device that is capable of de-spreading data with the first pre-defined code.

24. The spread spectrum communication network of claim 21, wherein the second communication device is operable to communicate with a mobile communication device that is capable of de-spreading data with the second pre-defined code.

25. A spread spectrum multiple access code for use in a spread spectrum multiple access system, wherein the spread spectrum multiple access code is embodied in a processor readable memory and comprises:
a predetermined spread spectrum multiple access code with an ideal periodic auto-correlation function,
a first plurality of elements appended to a first end of the predetermined spread spectrum multiple access code, and
a second plurality of elements appended to a second end of the predetermined spread spectrum multiple access code,
wherein the first plurality of elements are identical to one subset of elements of the predetermined spread spectrum multiple access code and wherein the second plurality of elements are identical to another subset of elements of the predetermined spread spectrum multiple access code, wherein a non-periodic auto-correlation function of the spread spectrum multiple access code has a zero-correlation window, and wherein the spread spectrum multiple access code is utilized by a processor to spread data.

26. The spread spectrum multiple access code of claim 1 wherein a width of the zero-correlation window equals a sum of the number of elements in the first plurality and the second plurality.

27. A spread spectrum multiple access code group for use in a spread spectrum multiple access system, the spread spectrum multiple access code group including at least a first spread spectrum multiple access code and a second spread spectrum multiple access code, wherein the spread spectrum multiple access codes are embodied in at least one processor readable memory and each comprise:
a predetermined spread spectrum multiple access code with an ideal periodic auto-correlation function,
a first plurality of elements appended to a first end of the predetermined spread spectrum multiple access code, and
a second plurality of elements appended to a second end of the predetermined spread spectrum multiple access code,
wherein the first plurality of elements are identical to one subset of elements of the predetermined spread spectrum multiple access code and wherein the second plurality of elements are identical to another subset of elements of the predetermined spread spectrum multiple access code,
wherein a non-periodic auto-correlation function of each of the spread spectrum multiple access codes has a zero-correlation window, and wherein the spread spectrum multiple access codes are utilized by at least one processor to spread data.

28. The spread spectrum multiple access code of claim 25, wherein a non-periodic cross-correlation function between the first spread spectrum multiple access code and the second spread spectrum multiple access code has a zero-correlation window.
